(19) United States
(12) Patent Application Publication
(10) Pub. No.: US 2006/0201744 A1
(43) Pub. Date: Sep. 14, 2006

(54) Elevator shaft safety net system

(76) Inventors: Susan Curtis, Snow Hill, MD (US); David K. Dypsky, Ocean City, MD (US)

Correspondence Address: OBER|KALER;c/o Royal W. Craig, 120 East Baltimore Street, Baltimore, MD, 21202, US

(21) Appl. No.: 11/375,613

(22) Filed: Mar. 14, 2006

Related U.S. Application Data
(60) Provisional application No. 60/661,589, filed on Mar. 14, 2005.

(51) Int. Cl. A62B 1/22

(52) U.S. Cl. 182/138

(57) ABSTRACT

An elevator safety net system for preventing people, equipment, or debris from falling down commercial or residential elevator shafts during building construction, in each case avoiding injury. The net is a high-quality synthetic double-layer net with reinforced borders encased in fabric-sealed edges, and a plurality of steel grommets around the edges of the safety net. A plurality of safety nets may be suspended laterally up and down an elevator shaft before the elevator is installed, and this is done by screwing in eight eye bolts around the elevator shaft so that the safety net can be attached/suspended by snapping in closed steel hooks that connect the eye bolts to corresponding steel grommets of the net, thereby suspending the nets up and down the elevator shaft. The nets can be removed and reinstalled for future maintenance of the elevator shaft by snapping the hooks on and off the eye bolts screwed into the elevator shaft. Thus, if someone or something falls into the elevator shaft during post-construction maintenance, the net will be available to catch the person or thing without harm to themselves or others.

### CROSS-REFERENCE TO RELATED APPLICATION(S)

The present application derives priority from U.S. provisional application No. 60/661,589 filed Mar. 14, 2005.

### BACKGROUND OF THE INVENTION

1. Field of the Invention

The present invention relates to a safety net system for catching objects falling down open elevator shafts, and more particularly to catching an individual and/or equipment falling in a residential or commercial elevator shaft during all stages of construction, including post-construction maintenance.

2. Description of the Background

Falls from elevation hazards are present at most every jobsite, and many workers are exposed to these hazards daily. Any unprotected shaft can pose a potential fall hazard. In the construction industry, falls lead all other causes of occupational death. For this reason, the Occupational Safety and Health Administration (OSHA) publishes regulations (set forth in 29 CFR), which include Standard Number: 1926.501, the “Duty to have fall protection.” OSHA has added criteria pertaining to personal fall protection systems, including standards for fall arrest systems.

During construction, it is known to use nets, screens and barriers to prevent people or equipment falling down an open shaft. For example, U.S. Pat. No. 5,167,299 issued to Nusbaum on Dec. 1, 1992 discloses a safety net arrangement for building elevator shafts. The net can be made of open work netting material or closed webbing such as a cargo net.. This net is attached to two pairs of resilient elongated tethers made of elastic cord or webbing (i.e. bungee cords). Each tether has an upper end connected to eye-bolts or analogous fastening devices. The tethers allow controlled descent of the person/object. The net can be in open or closed position. When the net is in operation, it is in open position. The net automatically closes during the descent of an object and is maintained in a closed state by closure rings that slide along tethers attached to the net.

Another device used to prevent falls in elevator shafts is disclosed in U.S. Pat. No. 6,758,306 issued to Walls et. al on Jul. 6, 2004, which shows a construction safety screen system. This screen system includes a fastening border, fasteners, netting apertures, and netting material. This screen system uses a hook bolt for hanging the safety screen to the top of a framework, which can include an elevator shaft. It also uses an eye bolt for anchoring the construction safety screen to the bottom of the framework.

The aforementioned devices suffer from a number of drawbacks, most notably, they cannot be used to catch someone or something when falling during all phases of construction, especially during finishing and post-construction maintenance. The aforementioned devices use vertically hung nets which may stop falls by creating a temporary barrier, but when that barrier is removed, nothing protects the safety of a person from a fall into the open shaft. Furthermore, the aforementioned devices do not use fixed hooks through steel grommets in the entire net which prevent tearing and weakening of the net.

To the best of the knowledge of the present inventor, no prior elevator shaft safety net intended to address all of the problems outlined above exists. Therefore, there remains a need for an improved elevator shaft safety net system, and it would be greatly advantageous to provide an elevator shaft safety net system that uses snap-in closed steel hooks rather than straps to hold the net, because this would increase the reliability of the net since straps can become loose or broken. Moreover, there is a need for a horizontally hung net that will not only catch a falling person but also debris and tools if dropped down the shaft. Furthermore there is a need for fixed eye bolts that remain in the shaft throughout the construction process and beyond for future use if the net needs to be installed because of maintenance in the shaft.

### SUMMARY OF THE INVENTION

It is, therefore, the primary object of the present invention to provide an improved elevator shaft safety net system which uses snap-in closed steel hooks that connect to eye bolts that remain in the elevator shaft so the safety net can be used to catch individuals or equipment falling down the shaft, at all phases of the construction process.

It is another object of this invention to provide an easy-to-use snap hook system to ensure use by construction workers.

It is still another object of this invention is to provide a safety net that meets or exceeds all applicable Occupational Safety and Health Administration (OSHA) and American National Standards Institute (ANSI) requirements.

Yet another object of the present invention is to provide an economical elevator shaft safety net system that is easy to manufacture to provide for widespread, cost-effective use.

These and other objects are accomplished by an elevator shaft safety net made of a dual-layer high-quality cotton or synthetic net with fabric-sealed edges that encase a synthetic rope, and a plurality of steel grommets around the edges of the safety net. A plurality of these elevator shaft safety nets are suspended laterally up and down an elevator shaft before the elevator has been installed, and this is done by screwing in a number of eye bolts around the elevator shaft so that the elevator shaft safety net can be attached/suspending by hooking (using steel snap-in closed hooks) the steel grommets of the net to the eye bolts that have been screwed into the elevator shaft, thereby suspending the nets up and down the elevator shaft. If someone falls in or equipment falls in they/it will fall a few feet without harm to themselves or others.

The present invention's design is simple and straightforward, highly effective and can be economically manufactured and installed. Additional objectives, features and advantages will be apparent in the written description which follows.

### BRIEF DESCRIPTION OF THE DRAWINGS

Other objects, features, and advantages of the present invention will become more apparent from the following detailed description of the preferred embodiments and certain modifications thereof when taken together with the accompanying drawings in which:

FIG. 1A is a perspective view of the net 1 suspended horizontally at the highest level of the shaft during construction.

FIG. 1B is a perspective view of the net 1 suspended horizontally in the middle of the shaft during construction.

FIG. 1C is a perspective view of the net 1 hanging from half of the snap-in closed steel hooks 4 during construction.

FIG. 1D is a perspective view of the net 1 unhooked from three of the snap-in closed steel hooks 4 during construction.

FIG. 2 is a perspective view of the present invention after the elevator car 8 is installed.

FIG. 3A is a close-up view of the eye bolt 5 screwed into the board/block 6.

FIG. 3B is close-up view of the eye bolt 5 screwed into board/block 6 with drywall 10 covering the board/block 6.

FIG. 4 is a close-up view of the net 1 with grommets 3 and snap-in closed steel hooks 4 connecting through the grommets 3 around the fabric-sealed edges 2.

FIG. 5A is a top view of the elevator shaft 7 after the elevator car 8 is installed.

FIG. 5B is a side view of the elevator shaft 7 after the elevator is installed.

### DETAILED DESCRIPTION OF THE PREFERRED EMBODIMENTS

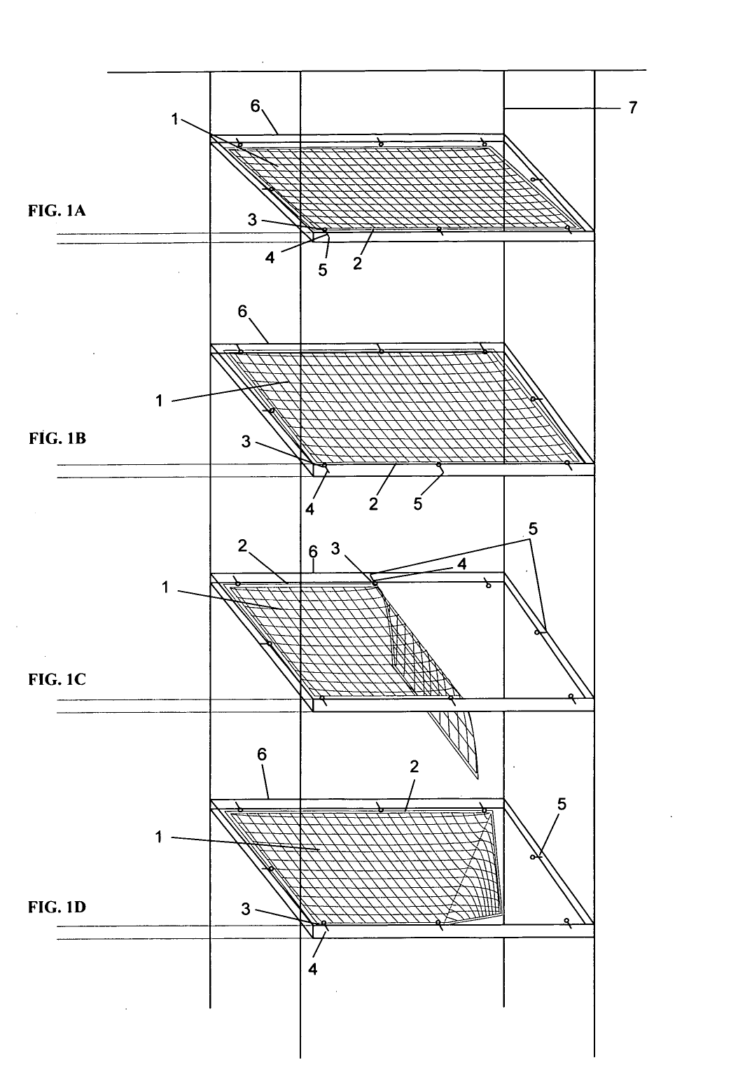

The present invention is an elevator shaft safety net system. In accordance with a preferred embodiment of the present invention as shown in FIG. 1 (A-D), the elevator shaft safety net system generally comprises a dual-layer net 1 with rope-encased fabric-sealed edges 2 and a plurality of steel grommets 3 attached through the fabric edges 2 around the periphery of the net 1. One or more such nets 1 are attached horizontally within the elevator shaft via a plurality of snap-in locking steel hooks 4 each connected to a corresponding steel grommet 3, the hooks 4 in turn being connected to eye bolts 5 that are screwed into the board/block 6 of the elevator shaft frame below floor level. For each net 1, a total of eight eye bolts 5 are screwed into the four sides of the elevator shaft 7.

As can be seen in FIGS. 1A, 1B, 1C and 1D, the net 1 is attached by eight spring-lock steel hooks 4 hooked around eight corresponding steel grommet 3, the other end of hooks 4 being attached to eight eye bolts 5 screwed in to a board/block 6 of the elevator frame below floor level. FIGS. 1A and 1B show the net 1 fully horizontally suspended as it is attached to all eight of the eye bolts 5 that are screwed into the board/block 6 at these floors in the shaft. FIG. 1C illustrates the capability of the net 1 to be unhooked from the eye bolts 5, when it is desired to do so. In FIG 1C, the net 1 is only attached to the eye bolts 5 in the center and left side of the shaft 7. FIG. 1D illustrates that the net 1 can be easily unhooked from as many of the eye bolts 5 in the board/block 6 as desired (consistent with safety) to gain access for working on the elevator.

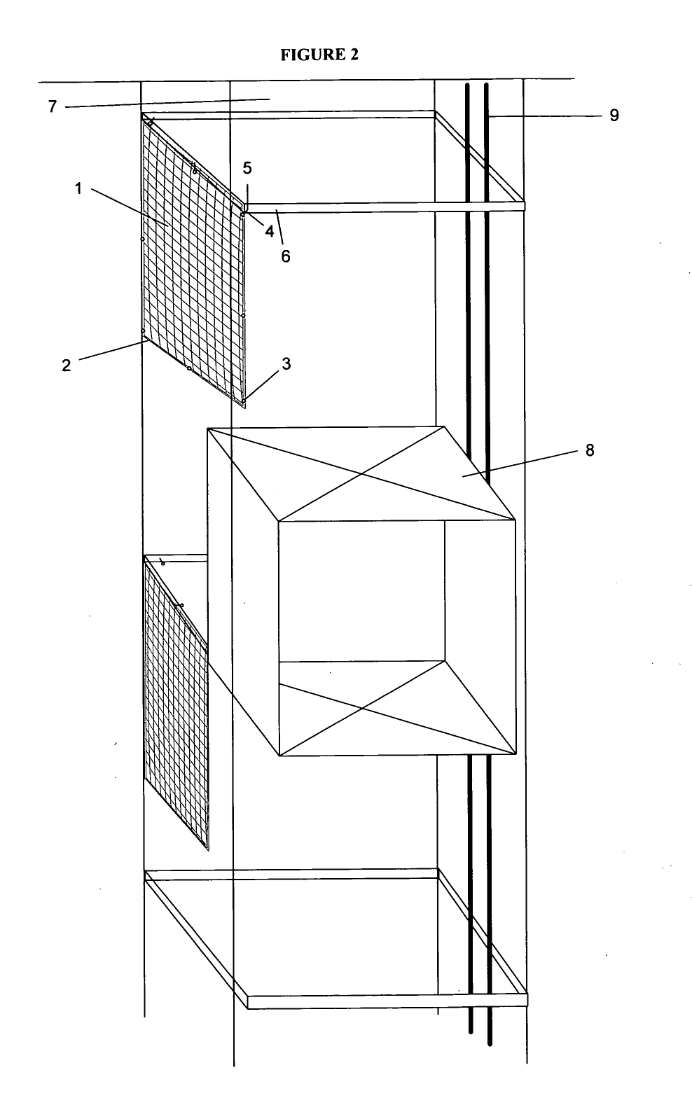

FIG. 2 shows the net 1 hanging from three eye bolts 5 on only one side of the shaft 7 and thus the net 1 is hanging down vertically in the shaft 7. It can be seen that the net 1 will hang down vertically in the shaft 7, if desired, when the elevator car 8 is in operation. The benefit of leaving the net 1 hanging in the shaft 7 is that it is available for use during maintenance of the tracks 9 even after the elevator car 8 is installed. Otherwise, the net 1 may be fully reattached. Thus the net 1 can be used at all stages of the construction process, including post-construction maintenance.

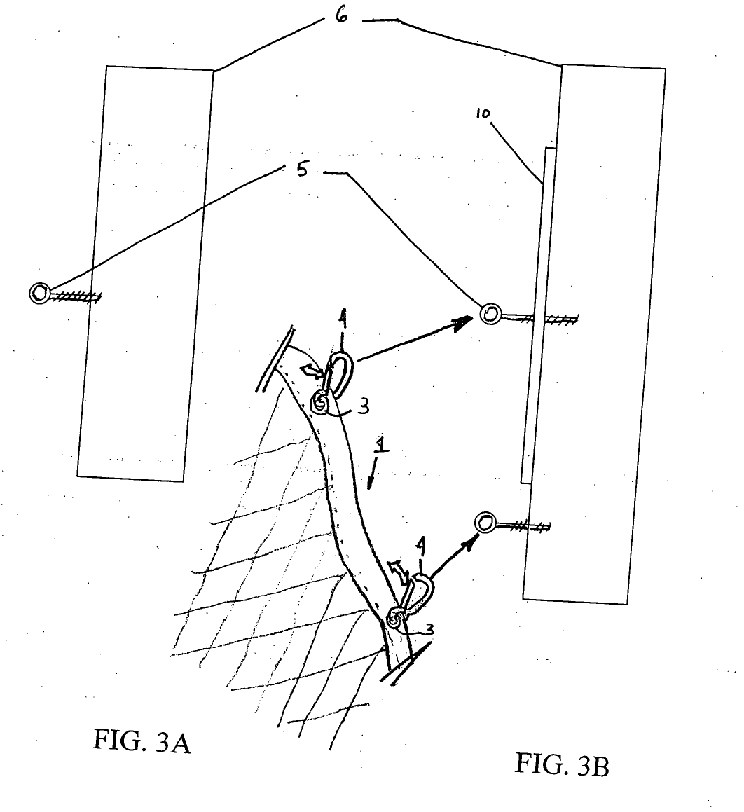

FIGS. 3A and 3B are detailed views of the eye bolt 5 that is screwed into the board/block 6. FIG. 3A shows an eye bolt 5 screwed into a block 6 made of concrete. FIG. 3B is an alternate embodiment showing an eye bolt 5 which is screwed into a block 6 made of wood. The drywall 10 may be applied on top of the block 6 made of wood without removing the eye bolt 5. This is particularly advantageous during the construction process because this will save time and effort. All eye bolts 5 are preferably 4″×¼″ stainless steel eye bolts. FIGS. 3A and 3B also show in detail the hooks 4 attached to grommets 3 in net 1 as they couple to the eye bolts 5 screwed into the board/block 6. All hooks 4 are preferably marine-grade stainless steel locking hooks with pivoted normally-closed spring-detent fingers for locking the hooks 4 closed as shown. A variety of self locking eye hooks are commercially available for this purpose.

The net 1 used in the present invention is specially fabricated of two layers of suitable synthetic netting material. Specifically, the top layer is debris netting formed of ⅜″ square mesh knitted polyethylene threads with a reinforced thread border. The debris netting layer is preferably a brightly-colored netting that functions primarily to catch falling debris or tools that fall into the shaft. The underlying layer is formed of a black synthetic personnel safety netting woven with an approximate 3½″ shock absorbing diamond mesh, and this personnel safety layer should meet or exceed ANSI A10.11 (1989). The personnel safety layer is bordered with 5,000-pound minimum-test synthetic rope. The synthetic rope border of the personnel safety layer as well as the reinforced thread border of the debris netting are encased in the fabric-sealed edges 2, wrapped around the outside of the steel grommets 3 (which are attached through the fabric edges 2 around the periphery of the net 1). This configuration provides dual-function debris-catching as well as personnel safety functionality and serves to strengthen the combined strength specifications of the net 1 (meeting or exceeding OSHA and ANSI standards). If desired, both layers of the net 1 may be treated with inhibitors that protect it from normal wear and tear as well as ultraviolet degradation. The fabric-sealed edges 2 comprise a synthetic fabric (Vinyl [tm] or the like) sleeve stitched together to form a casing around the synthetic rope border of the personnel safety layer as well as the reinforced thread border of the debris netting.

The preferred embodiment of the present invention allows for the net 1 to be removed after the elevator car 8 is installed; and allows the net 1 to be reinstalled by hooking it into place for future maintenance, thus making the elevator shaft safety net system available during all stages of the construction process.

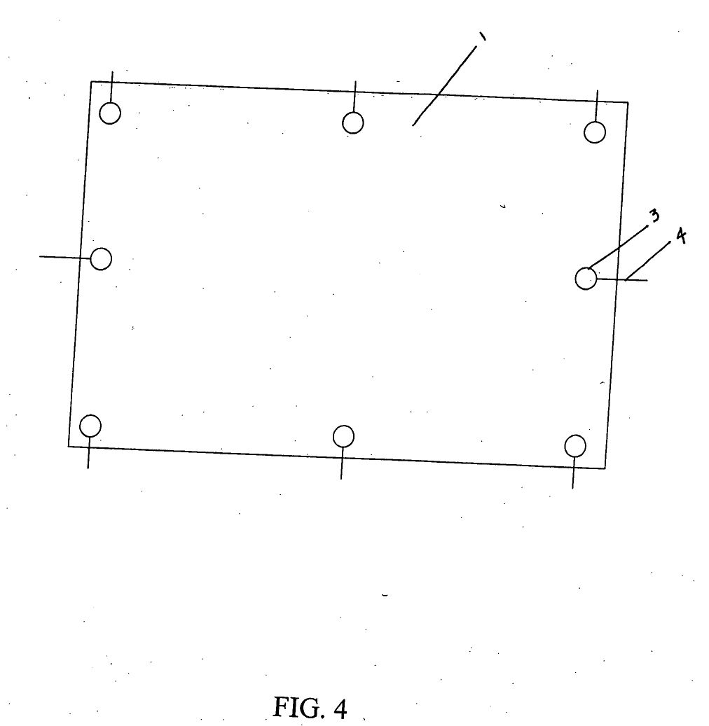

FIG. 4 is a schematic view showing the installation configuration of the eight eye bolts 5 around the shaft. On the long side of the shaft, the eye bolts 5 should be anchored two inches from the corner and four inches below the floor level. Then the eye bolts 5 should be measured and anchored in the middle of the sides of the shaft 7. The distance between where the eye bolts 5 are anchored and the floor level will never be more than about four inches, and so if a large net 1 is ordered for a large commercial elevator shaft 7 then there will be more than one center eye bolt 5 and snap-in closed steel hook 4.

In use, of the present system, a plurality of nets 1 are installed in each exposed elevator shaft, one net 1 at each floor just beneath floor level. Each net 1 is installed by tapping and screw-inserting the eight eye bolts 5. FIG. 4 is a schematic view showing the installation configuration of the eight eye bolts 5 around the shaft. On the long side of the shaft, the eye bolts 5 should be anchored two inches from the corner and four inches below the floor level. Then the eye bolts 5 should be measured and anchored in the middle of the sides of the shaft 7. The distance between where the eye bolts 5 are anchored and the floor level will never be more than about four inches and so if a large net 1 is ordered for a large commercial elevator shaft 7 then there will be more than one center eye bolt 5 and snap-in closed steel hook 4. The hooks 4 are pre- attached to grommets 3 in net 1, and are readily coupled to the corresponding eye bolts 5 by depressing the normally-closed spring-detent fingers, inserting the hooks 4 into the eye bolts 5, and releasing the spring detent fingers to lock the hooks 4 thereon as shown (see FIG. 3).

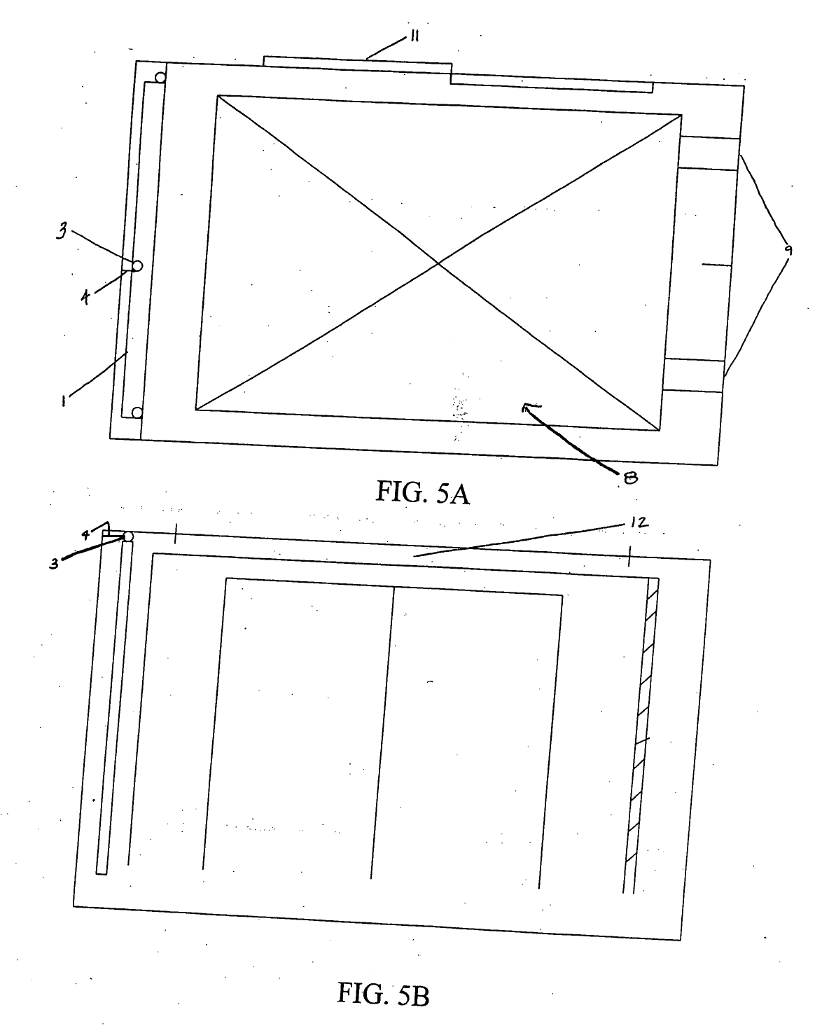

FIGS. 5A and 5B show the net 1 hanging vertically on one side of the shaft 7 after the elevator car 8 is installed. FIG. 5A is a top view of the elevator shaft 7. The net 1 is hanging on one side of the elevator doors 11 and the tracks 9 are located on the other side of the elevator doors 11. If the tracks 9 need maintenance after the elevator car 8 is installed, the net 1 on the floor below the one whose tracks 9 need maintenance, may be utilized. The net 1 will be hooked to the eye bolts 5 in front of the doors 11 and across from the doors 11, and also in front of the tracks 9 on the floor below the one that needs maintenance. Thus a total of eight eye bolts 5 will be used. FIG. 5B is a side view of the elevator shaft 7 after the elevator car 8 is installed. FIG. 5B also shows the net 1 hanging vertically after the car is installed. The net 1 is suspended via a snap-in closed steel hook 4 connecting through a grommet 3 around the edge of the net 1. In FIG. 5B the elevator car 8 has stopped at a floor 12 in the elevator shaft 7.

As is evident from the above disclosure, the present invention possesses a simple design that is easy-to-use and that may be economically manufactured and sold to provide for widespread use.

Having now fully set forth the preferred embodiment and certain modifications of the concept underlying the present invention, various other embodiments as well as certain variations and modifications of the embodiments herein shown and described will obviously occur to those skilled in the art upon becoming familiar with said underlying concept. It is to be understood, therefore, that the invention may be practiced otherwise than as specifically set forth in the appended claims.

I claim :

1. An elevator shaft safety net system comprising:
a net having fabric-encased edges;
a plurality of steel grommets around the fabric-encased edges of said net;
a corresponding plurality of eye bolts screwed into walls of said elevator shaft; and
a plurality of steel snap-lock eye hooks that connect said grommets to said eye bolts.

2. The elevator shaft safety net system according to claim 1 wherein said net comprises two layers of netting including a top layer of debris netting and underlying layer of personnel safety netting.

3. The elevator shaft safety net system according to claim 1 wherein said underlying layer of personnel safety netting comprises synthetic strands woven with a shock-absorbing diamond mesh.

4. The elevator shaft safety net system according to claim 3 wherein said top layer of debris netting comprises polyethylene threads woven I a ⅜″ square mesh.

5. The elevator shaft safety net system according to claim 4 wherein both of said underlying layer of personnel safety netting and top layer of debris netting comprise reinforced rope borders.

6. The elevator shaft safety net system according to claim 5 wherein the reinforced rope border of said personnel safety netting comprises a 5,000-pound capacity synthetic rope.

7. The elevator shaft safety net system according to claim 6 wherein both rope borders of said underlying layer of personnel safety netting and top layer of debris netting are encased in the fabric-sealed edges of said net.

8. The elevator shaft safety net system according to claim 7 wherein the plurality of steel grommets are spaced around the fabric-encased edges of said net and penetrate said edges, and both rope borders of said underlying layer of personnel safety netting and top layer of debris netting are wound around said plurality of steel grommets.

9. The elevator shaft safety net system according to claim 1 wherein the plurality of eye bolts include eye bolts anchored in said elevator shaft walls approximately two inches on each side of each corner approximately four inches below each floor level.

10. The elevator shaft safety net system according to claim 1 wherein the plurality of steel snap-lock eye hooks each comprise an eye attached to a corresponding grommet in said net and a hook attached to a corresponding eye bolt in said elevator shaft walls.

11. The elevator shaft safety net system according to claim 10 wherein the plurality of steel snap-lock eye hooks each comprise a normally-closed spring-lock hook attached to a corresponding eye bolt in said elevator shaft walls.

12. The elevator shaft safety net system according to claim 10 wherein the plurality of steel snap-lock eye hooks each comprise an eye attached to a corresponding grommet in said net and a hook attached to a corresponding eye bolt in said elevator shaft walls.

13. An elevator shaft safety net system comprising:
a dual-layer net including a top layer of debris netting and underlying layer of personnel safety netting, both of said underlying layer of personnel safety netting and top layer of debris netting further comprising a reinforced rope border, both rope borders of said underlying layer of personnel safety netting and top layer of debris netting being encased in fabric-sealed edges of said net;
a plurality of steel grommets spaced around the fabric-encased edges of said net and penetrating said edges, both rope borders of said underlying layer of personnel safety netting and top layer of debris netting being wound outside said plurality of steel grommets;
a corresponding plurality of eye bolts screwed into walls of said elevator shaft; and
a plurality of steel snap-lock eye hooks that connect said grommets to said eye bolts.

14. The elevator shaft safety net system according to claim 13 wherein said underlying layer of personnel safety netting comprises synthetic strands woven with a shock-absorbing diamond mesh.

15. The elevator shaft safety net system according to claim 14 wherein said top layer of debris netting comprises polyethylene threads woven I a ⅜″ square mesh.

16. The elevator shaft safety net system according to claim 15 wherein the reinforced rope border of said personnel safety netting comprises a 5,000-pound capacity synthetic rope.

17. The elevator shaft safety net system according to claim 16 wherein the plurality of eye bolts include eye bolts anchored in said elevator shaft walls approximately two inches on each side of each corner approximately four inches below each floor level.

18. The elevator shaft safety net system according to claim 13 wherein the plurality of steel snap-lock eye hooks each comprise an eye attached to a corresponding grommet in said net and a hook attached to a corresponding eye bolt in said elevator shaft walls.

19. The elevator shaft safety net system according to claim 18 wherein the plurality of steel snap-lock eye hooks each comprise a normally-closed spring-lock hook attached to a corresponding eye bolt in said elevator shaft walls.

20. A method of preventing people or equipment from falling down elevator shafts using a net having fabric-encased edges, a plurality of steel grommets around the fabric-encased edges of said net, a corresponding plurality of eye bolts screwed into walls of an elevator shaft, and a plurality of steel snap-lock eye hooks that connect said grommets to said eye bolts, said method comprising the steps of:
hooking all of said plurality of grommets of said net to said plurality of eye bolts such that said net is suspended horizontally in said shaft;
suspending a plurality of said safety nets laterally up and down said elevator shaft before the elevator is installed;
unhooking selected grommets from said eye bolts while said elevator is operating such that said net is suspended vertically on one side of said shaft; and
rehooking all of said plurality of grommets of said net to said plurality of eye bolts such that said net is suspended horizontally in said shaft for post-construction maintenance.
